(19) United States
(12) Patent Application Publication
(10) Pub. No.: US 2018/0225711 A1
(43) Pub. Date: Aug. 9, 2018

(54) DETERMINING AD RANKING AND PLACEMENT BASED ON BAYESIAN STATISTICAL INFERENCE

(71) Applicant: MyLikes, Inc., San Francisco, CA (US)

(72) Inventors: Prathab Murugesan, San Francisco, CA (US); Arvind Sundararajan, San Francisco, CA (US); Jayesh Kapoor, San Mateo, CA (US); Divyam Goel, San Francisco, CA (US); Shrey Sharma, San Francisco, CA (US)

(21) Appl. No.: 15/427,550

(22) Filed: Feb. 8, 2017

(51) Int. Cl. G06Q 30/02

(52) U.S. Cl. CPC G06Q 30/0254; G06Q 30/0272

(57) ABSTRACT

A system and method may be used to automatically select one of a plurality of advertisements to display on a computing device, for example, via online delivery of a gallery last-page advertisement or the like. A prior probability distribution may be obtained, and may be indicative of the relative likelihood of activation of the plurality of advertisements by a user. Bayesian statistical inference may be applied to the prior probability distribution to generate a posterior probability distribution that indicates relative likelihood of activation of the plurality of advertisements by the user, for example, with greater accuracy than the prior probability distribution. The posterior probability distribution may be used to select a first advertisement of the plurality of advertisements. A signal may be transmitted to cause the first advertisement to be displayed to the user.

### TECHNICAL FIELD

The present document relates to selection of advertising content to be shown online.

### DESCRIPTION OF THE RELATED ART

There are many online venues in which advertisements are displayed. These include web sites, social media platforms, and the like. Often, a manager of advertising space on the web site or social media platform has a variety of different ads that could be displayed within a given available space. One particular example is a gallery last-page advertisement. A gallery may include pictures and/or text displayed in the form of a slide show. The user may activate (for example, by clicking or tapping) a “next” button or the like to advance the gallery to the next page. The last page may be an advertisement; once the user activates the advertisement (for example, by clicking or tapping on the advertisement or on the “next” button on the advertisement page), he or she may be taken to a landing page associated with the advertisement.

The manager of the advertising space may offer to display advertisements by auctioning off impressions of advertisements for a cost-per-click, or “CPC,” that the advertiser is willing to pay for a user activation of the advertisement. Comparison of different CPC's for different advertisements, alone, does not reveal the advertisement that will provide the greatest revenue (often quantified in terms of revenue per million impressions, or “RPM”), because this depends on how many users click on the advertisement displayed. Accordingly, the manager of the advertising space may find it beneficial to attempt to predict the click-through-rate (“CTR”) of a given advertisement.

Traditional approaches for estimating the CTR of an advertisement attempt to model the RPM as a combination of features such as the demographics of the user, the social page from which the user arrived at the site displaying the advertisement, the time of day, the targeting demography of the advertiser, the keywords provided by the advertiser, and the like. A sigmoid function or the like may be used to model the probable CTR.

Unfortunately, there are many drawbacks to such an approach. Feature engineering is a time-consuming process. Further, the features on which the function is based are usually under-specified. As new types of advertisements are added to the system, features may need to be updated. Further, this approach suffers from a difficult “cold start” scenario, in which there is no previous data for an advertisement, from which the features can be extracted.

### SUMMARY

Various embodiments of the present disclosure provide systems and methods whereby one of a plurality of advertisements can be selected for display on a computing device. In some embodiments, a method may include obtaining a prior probability distribution indicative of relative likelihood of activation of the plurality of advertisements by a user. Bayesian statistical inference may be applied to generate a posterior probability distribution from the prior probability distribution. The posterior probability distribution is also indicative of relative likelihood of activation of the plurality of advertisements by the user. The posterior probability distribution may be used to select a first advertisement from the plurality of advertisements. A signal may be transmitted to cause the first advertisement to be displayed to the user.

Obtaining the prior probability distribution may entail generating the prior probability distribution independently of any activation history of the plurality of advertisements. Further, generating the prior probability distribution may include utilizing other activation history for other advertisements excluding the plurality of advertisements. The plurality of advertisements may be from advertisers offering a range of costs per click for each user activation of the plurality of advertisements. The other advertisements may be from other advertisers offering an other range of costs per click for each user activation of the other advertisements. The other range of costs per click may be the same as or similar to the range of costs per click. The other activation history may be indicative of a number of times the other advertisements have been activated by users.

Alternatively, obtaining the prior probability distribution may include obtaining a previous prior probability distribution indicative of relative likelihood of activation of the plurality of advertisements by a user and applying Bayesian statistical inference to the previous prior probability distribution to generate a previous posterior probability distribution that is also indicative of relative likelihood of activation of the plurality of advertisements by the user. The previous posterior probability distribution may be designated as the prior probability distribution.

Using the posterior probability distribution to select the first advertisement from the plurality of advertisements may include determining that the first advertisement is more likely to be activated by the user than a second advertisement of the plurality of advertisements. Using the posterior probability distribution to select the first advertisement from the plurality of advertisements may further include determining that the first advertisement is more likely to be activated by the user than a second or third advertisement of the plurality of advertisements.

Applying Bayesian statistical inference to the prior probability distribution to generate the posterior probability distribution may include retrieving activation history indicative of a number of times the plurality of advertisements have been activated by users, and generating the posterior probability distribution based, at least partially, on the activation history. The activation history may include a plurality of features for each advertisement of the plurality of advertisements. The plurality of features may include a number of times the advertisement has been activated, with no time limit, a number of times the advertisement has been activated within a recent window of time, and/or a number of times the advertisement has been activated on a venue in which the advertisement is to be displayed for the user, with no time limit.

Transmitting the signal to cause the first advertisement to be displayed to the user may include causing the advertisement to be displayed on a last page of a gallery of content selected for display by the user. Thus, the advertisement may be shown as a gallery last-page advertisement. In other embodiments, the first advertisement can be displayed in other ways.

### BRIEF DESCRIPTION OF THE DRAWINGS

The accompanying drawings, together with the description, illustrate several embodiments. One skilled in the art will recognize that the particular embodiments illustrated in the drawings are merely exemplary, and are not intended to limit scope.

FIG. 1A is a block diagram depicting a hardware architecture according to one embodiment.

FIG. 1B is a block diagram depicting a hardware architecture in a client/server environment, according to one embodiment.

FIG. 2 is a block diagram depicting data that may be stored in connection with advertisements, according to one embodiment.

FIG. 3 is a block diagram depicting a system for determining advertisement placement, according to one embodiment.

FIG. 4 is a flowchart diagram depicting a method for determining advertisement placement, according to one embodiment.

FIGS. 5A through 5D are screenshot diagrams depicting various pages in a gallery, culminating in a gallery last-page advertisement, according to one embodiment.

### DETAILED DESCRIPTION OF THE EMBODIMENTS

The systems and methods set forth herein may be applied in a wide variety of contexts in which the best advertisement for a given position is to be determined. In particular, the systems and methods provided herein can provide unique benefits where a manager of advertising space has multiple advertisements, only one of which can be shown in the position under consideration, at a given time. One exemplary context is online advertising, in which an advertisement is to be displayed in a particular location on a web page, social media page, gallery, or other content that can be browsed online.

Many advertising platforms operate through the use of an ad auction model. The advertiser submits the advertisement, and offers to pay a specific cost-per-click, or “CPC,” for each instance in which a viewer selects, or “activates,” the advertisement. Typically, selecting an advertisement causes the viewer to be directed to a landing page where the user can obtain more information, purchase a product or service, or the like. The manager of the advertising space may have multiple advertisements that have been submitted by advertisers, and each may have an associated CPC. The manager of the advertising space then needs to determine which advertisement, when placed in the space, will provide the highest revenue per million impressions (“RPM”). This will be a function of CPC and the click-through-rate (“CTR”) of the advertisement. Accordingly, the ability to predict CTR accurately can help the advertising manager to make much better decisions, thereby enhancing RPM.

Further, in some embodiments, such predictions of CTR can be incorporated into the determination of which advertisement is displayed in real time (for example, within one minute of the time the viewer does or does not activate the advertisement). This process may be automated such that advertisement placement decisions may be automated, and may always be made with the benefit of recent activation history.

In this application, a “computing device” can be any device capable of processing digital data. A “processor” is a hardware element of a computing device that processes digital data. A “data store” is any device capable of digital short-term and/or long-term data storage. A data store may use any known hardware for nonvolatile and/or volatile data storage.

A “network system” is a collection of computing devices that are connected together to permit communication between the computing devices. A “distributed computing system” is a network system, which may optionally exist within a more extensive network system, in which the computing devices cooperatively carry out one or more computing tasks. A network system may optionally include a distributed computing system and one or more computing devices that are not part of the distributed computing system.

An “advertisement” is information, which may include text, images, video, and/or sound, which can be activated by a user. “Activation” of an advertisement is user selection of the advertisement, for example, by clicking or tapping on the information in the advertisement to obtain more information or to be routed to a purchasing portal. “Activation history” is information regarding one or more advertisements that have been presented to one or more users, along with data regarding whether those advertisements were activated.

“Bayesian statistical inference” is a method by which Bayes' theorem is used to update a hypothesis regarding the probability of an event. A “prior probability distribution” is the hypothesis prior to performance of the update. A “posterior probability distribution” is the hypothesis after the update is carried out.

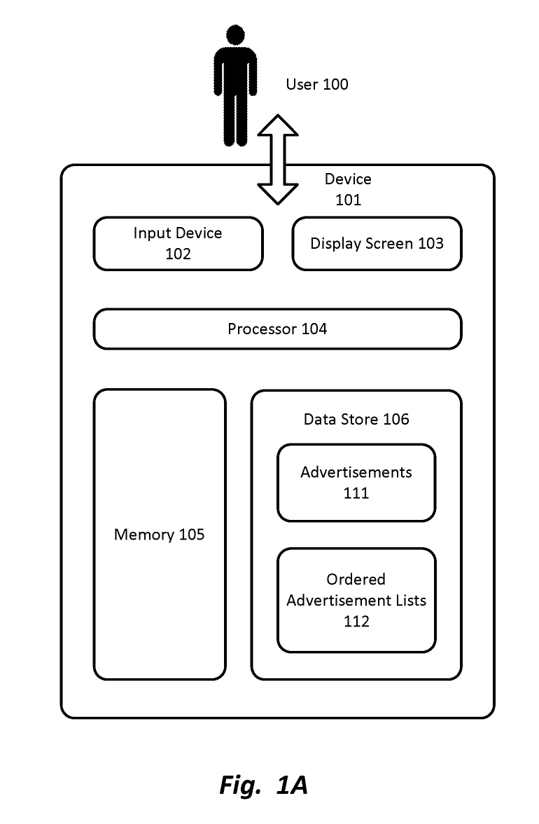

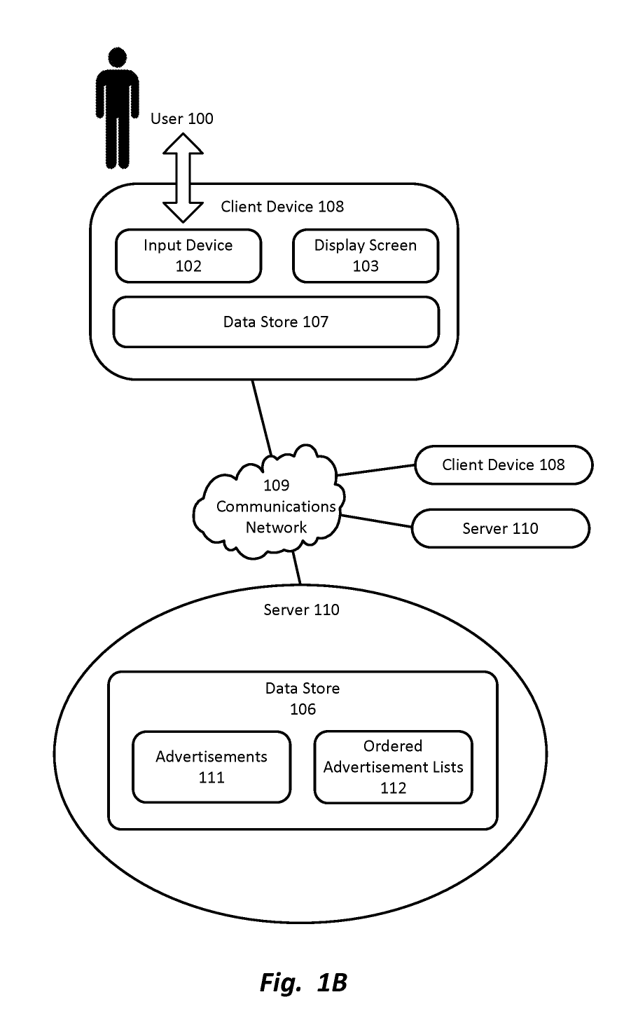

In some embodiments, one or more devices 101, client devices 108, and/or servers 110, as shown and described in FIGS. 1A and 1B, may be used to implement a system and method according to the present disclosure. Thus, in the figures and descriptions below, it will be understood that any of the components and/or method steps shown or described may be implemented in one or more of the devices 101, client devices 108, and/or servers 110.

### System Architecture

According to various embodiments, the system can be implemented on any one or more electronic devices equipped to receive, store, and present information. Such an electronic device may be, for example, a desktop computer, laptop computer, smartphone, tablet computer, smartphone/tablet (“phablet”), wearable computing device, and/or the like. Any of a wide variety of device types, operating systems, and the like may be used. Accordingly, the following description is intended to illustrate various embodiments by way of example, rather than to limit scope.

Referring now to FIG. 1A, there is shown a block diagram depicting a hardware architecture for practicing the described system, according to one embodiment. Such an architecture can be used, for example, for implementing the techniques of the system in a computer or other device 101. Device 101 may be any electronic device.

In at least one embodiment, device 101 has a number of hardware components well-known to those skilled in the art. Input device 102 can be any element that receives input from user 100, including, for example, a keyboard, mouse, stylus, touch-sensitive screen (touchscreen), touchpad, trackball, accelerometer, five-way switch, microphone, or the like. Input can be provided via any suitable mode, including for example, one or more of: pointing, tapping, typing, dragging, and/or speech. In at least one embodiment, input device 102 can be omitted.

Data store 106 can be any magnetic, optical, or electronic storage device for data in digital form; examples include flash memory, magnetic hard drive, CD-ROM, DVD-ROM, or the like. In at least one embodiment, data store 106 stores information that can be utilized and/or displayed according to the techniques described below. Data store 106 may be implemented in a database or using any other suitable arrangement. In another embodiment, data store 106 can be stored elsewhere, and retrieved by device 101 when needed for presentation to user 100. Data store 106 may store one or more data sets, which may be used for a variety of purposes and may include a wide variety of files, metadata, and/or other data. In at least one embodiment, data store 106 may include advertisements 111, ordered advertisement lists 112, and/or other data (not shown), such as data regarding advertisers and sites at which advertisements can be placed. In at least one embodiment, advertisements 111 and/or ordered advertisement lists 112 can be stored at another location, remote from device 101, and device 101 can access such advertisements 111 and/or ordered advertisement lists 112 via any suitable communications protocol.

Data store 106 can be local or remote with respect to the other components of device 101. In at least one embodiment, device 101 is configured to retrieve data from a remote data storage device when needed. Such communication between device 101 and other components can take place wirelessly, by Ethernet connection, via a computing network such as the Internet, via a cellular network, or by any other appropriate communication systems.

In at least one embodiment, data store 106 is detachable in the form of a CD-ROM, DVD, flash drive, USB hard drive, or the like. Information can be entered from a source outside of device 101 into a data store 106 that is detachable, and later displayed after the data store 106 is connected to device 101. In another embodiment, data store 106 is fixed within device 101.

In at least one embodiment, data store 106 may be organized into one or more well-ordered data sets, with one or more data entries in each set. Data store 106, however, can have any suitable structure. Accordingly, the particular organization of data store 106 need not resemble the form in which information from data store 106 is displayed to user 100. In at least one embodiment, an identifying label is also stored along with each data entry, to be displayed along with each data entry.

Display screen 103 can be any element that displays information such as text and/or graphical elements. The display screen 103 may optionally display the advertisements 111, ordered advertisement lists 112, data regarding the operation and performance of advertisements placed via the device 101, and/or the like. The display screen 103 may display any known user interface elements, including elements that modify the presentation of information on the display screen 103. In at least one embodiment where only some of the desired output is presented at a time, a dynamic control, such as a scrolling mechanism, may be available via input device 102 to change which information is currently displayed, and/or to alter the manner in which the information is displayed.

Processor 104 can be a conventional microprocessor for performing operations on data under the direction of software, according to well-known techniques. Memory 105 can be random-access memory, having a structure and architecture as are known in the art, for use by processor 104 in the course of running software.

Referring now to FIG. 1B, there is shown a block diagram depicting a hardware architecture in a client/server environment, according to one embodiment. Such an implementation may use a “black box” approach, whereby data storage and processing are done completely independently from user input/output. An example of such a client/server environment is a web-based implementation, wherein client device 108 runs a browser that provides a user interface for interacting with web pages and/or other web-based resources from server 110. Items from data store 106 can be presented as part of such web pages and/or other web-based resources, using known protocols and languages such as Hypertext Markup Language (HTML), Java, JavaScript, and the like.

Client device 108 can be any electronic device incorporating the input device 102 and/or display screen 103, such as a desktop computer, laptop computer, personal digital assistant (PDA), cellular telephone, smartphone, music player, handheld computer, tablet computer, kiosk, game system, wearable device, or the like. Any suitable type of communications network 109, such as the Internet, can be used as the mechanism for transmitting data between client device 108 and server 110, according to any suitable protocols and techniques. In addition to the Internet, other examples include cellular telephone networks, EDGE, 3G, 4G, long term evolution (LTE), Session Initiation Protocol (SIP), Short Message Peer-to-Peer protocol (SMPP), SS7, Wi-Fi, Bluetooth, ZigBee, Hypertext Transfer Protocol (HTTP), Secure Hypertext Transfer Protocol (SHTTP), Transmission Control Protocol/Internet Protocol (TCP/IP), and/or the like, and/or any combination thereof. In at least one embodiment, client device 108 transmits requests for data via communications network 109, and receives responses from server 110 containing the requested data. Such requests may be sent via HTTP as remote procedure calls or the like.

In one implementation, server 110 is responsible for data storage and processing, and incorporates data store 106. Server 110 may include additional components as needed for retrieving data from data store 106 in response to requests from client device 108.

As in FIG. 1A, data store 106 may be organized into one or more well-ordered data sets, with one or more data entries in each set. Data store 106, however, can have any suitable structure, and may store data according to any organization system known in the information storage arts, such as databases and other suitable data storage structures. As in FIG. 1A, data store 106 may include advertisements 111, ordered advertisement lists 112, and/or other data (not shown); alternatively, such advertisements 111, ordered advertisement lists 112, and/or other data can be stored elsewhere (such as at another server) and retrieved as needed.

In addition to or in the alternative to the foregoing, the advertisements 111 and/or the ordered advertisement lists 112 may also be stored in a data store 107 present in the client device 108. In some embodiments, the advertisements 111 and ordered advertisement lists 112 may have elements distributed between the server 110 and the client device 108 and/or other computing devices in order to facilitate secure and/or effective communication between these computing devices.

As in FIG. 1A, display screen 103 can be any element that displays information such as text and/or graphical elements. Various user interface elements, dynamic controls, and/or the like may be used in connection with the display screen 103.

As also set forth in FIG. 1A, processor 104 can be a conventional microprocessor for use in an electronic device to perform operations on data under the direction of software, according to well-known techniques. Memory 105 can be random-access memory, having a structure and architecture as are known in the art, for use by processor 104 in the course of running software.

In one embodiment, some or all of the system can be implemented as software written in any suitable computer programming language, whether in a standalone or client/server architecture. Alternatively, it may be implemented and/or embedded in hardware.

Notably, multiple servers 110 and/or multiple client devices 108 may be networked together, and each may have a structure similar to those of the client device 108 and the server 110 that are illustrated in detail in FIG. 1B. The data structures and/or computing instructions used in the performance of methods described herein may be distributed among any number of client devices 108 and/or servers 110.

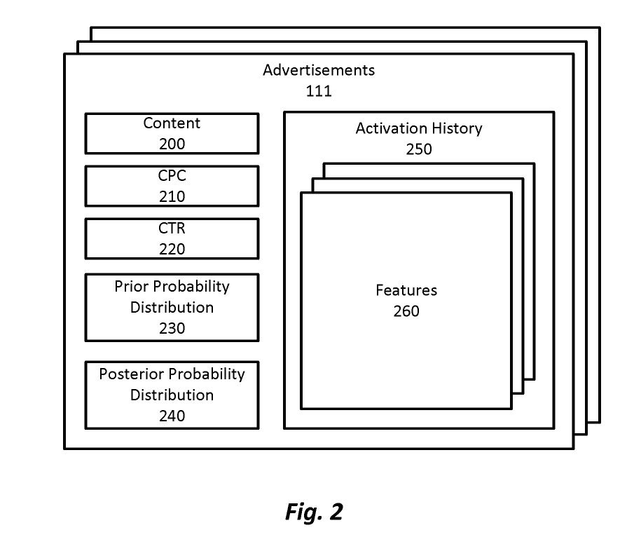

Referring to FIG. 2, there is shown a block diagram depicting data that may be stored in connection with advertisements, according to one embodiment. Specifically, the advertisements 111 of FIGS. 1A and 1B are depicted in greater detail. Each of the advertisements 111 may have content 200 provided by the advertiser. As described previously, this may include pictures, text, video, sound, and/or the like. Further, each of the advertisements 111 may have other data associated with it to facilitate performance of the methods set forth herein. For example, for each of the advertisements 111, any or all of a CPC 210, CTR 220, prior probability distribution 230, posterior probability distribution 240, and activation history 250 may be stored.

Like the content 200, the CPC may be obtained from the advertiser. For example, the advertising manager may use an auction model or a similar model by which advertisers indicate the CPC they are willing to pay when their advertisement is activated. Optionally, advertisers may also indicate a limit as to how much they are willing to spend to display advertisements within a given time frame. Such a limit, the amount remaining before the limit is reached, and/or the amount spent by the advertiser within a given time frame (not shown) may also be stored in connection each of the advertisements 111.

The auction may occur asynchronously. In some embodiments, the auction may be carried out offline and/or on a distributed system. Multiple computing systems such as servers may be used to conduct the auctions, generate the galleries, and/or transmit the advertisements to be shown. The results of the auction may be looked up and utilized later, after the auction has taken place. This may be done by providing, as results of the auction, an ordered list of the advertisements (one of the ordered advertisement lists 112) to be used in each advertising slot, as will be described in greater detail subsequently. The ordered advertisement lists 112 may be stored as key-value pairs in memory of one or more servers.

In some embodiments, advertising slots (or “venues”) may be broken down, bid for, and/or purchased by advertisers on the basis of various different factors. For example, advertisers may bid on ad space based on the advertisement context, which is the context in which the advertisement 111 will be presented to the user. Some features of advertisement context include, but are not limited to:
Time of day in which the advertisement 111 is to be presented;
The target demography of the advertisement 111 and/or the site on which the advertisement 111 is to be displayed;
The country and/or other location data regarding where the advertisement 111 will be shown;
Keywords present in the advertisement 111; and
Other metadata in the advertisement 111.

Additionally or alternatively, advertisers may bid on ad space based on the user context, which relates to the users to whom the advertisement 111 is to be presented. Some features of the user context include, but are not limited to:
The country and/or specific locality in which the user resides;
The web page, social site, and/or other origination from which the user navigated to the advertising slot (for example, for a gallery last-page advertisement 111, the social media site from which the gallery was launched);
The demographics of the user, such as age, gender, physical characteristics, and the like; and
Any interests or preferences provided by the user.

The CTR 220 may not be initially known. Even if there is activation history for the advertisement 111 on other platforms, that history may not provide an accurate gauge of the click-through rate the advertisement 111 will have in the particular space the advertising manager is attempting to fill. Accordingly, the statistical methods presented herein may be used to obtain a relatively accurate forecast of the CTR 210.

The RPM for each of the advertisements 111 may be obtained as the product of the CPC 210 and the CTR 220. For a given advertising slot, the advertising manager may wish to determine which of the advertisements 111 is likely to provide the highest RPM. The forecasted RPM may also optionally be stored in connection with each of the advertisements 111, if desired.

Each of the ordered advertisement lists 112 may be a list of advertisements for a given advertising slot, ordered by forecasted RPM. Thus, the advertisement in the ordered advertisement list 112 with the highest forecasted RPM may be displayed in each impression, as long as that advertisement retains the highest forecasted RPM, and as long as the volume of impressions is within the limitations set by the advertiser. Specifically, in some embodiments, the advertiser may be able to set a maximum number of impressions or activations, which may also optionally be stored in connection with each of the advertisements 111. Once the advertisement has received the maximum number of impressions or activations set by the advertiser, it may automatically be removed from or deprioritized on the ordered advertisement list 112 so that other advertisements 111 can be shown instead.

For each of the advertisements 111, the prior probability distribution 230 may be a probability distribution indicative of the likelihood that the advertisement 111 will be activated by the user, prior to application of Bayesian inference. The prior probability distribution 230 may exist in any form suitable for expressing probability. In some embodiments, a simple number may be used, such as a forecasted percentage of users that will activate the advertisement 111. In other embodiments, a more sophisticated probability distribution may be used, such as a beta distribution. A beta distribution is the probability density function (pdf) of the beta distribution, for 0≤x≤1, and shape parameters α, β>0, is a power function of the variable x and of its reflection (1−x) as follows:

$$\begin{matrix}f ( x ; α , β ) = constant \cdot {{x}^{α - 1} ( 1 - x )}^{β - 1} \\ = \frac{{{x}^{α - 1} ( 1 - x )}^{β - 1}}{{\int }_{0}^{1} {{u}^{α - 1} ( 1 - u )}^{β - 1} du} \\ = \frac{Γ ( α + β )}{Γ ( α ) Γ ( β )} {{x}^{α - 1} ( 1 - x )}^{β - 1} \\ = \frac{1}{B ( α , β )} {{x}^{α - 1} ( 1 - x )}^{β - 1}\end{matrix}$$

where Γ(z) is the gamma function. The beta function, B, is a normalization constant to ensure that the total probability integrates to 1.

In Bayesian inference, the beta distribution is the conjugate prior probability distribution for the Bernoulli, binomial, negative binomial and geometric distributions. For example, the beta distribution can be used in Bayesian analysis to describe initial knowledge concerning probability of success such as the probability that a space vehicle will successfully complete a specified mission.

Similarly, for each of the advertisements 111, the posterior probability distribution 240 may be a probability distribution indicative of the likelihood that the advertisement will be activated by the user, after application of Bayesian inference. Like the prior probability distribution 230, the posterior probability distribution 240 may exist any suitable form, including but not limited to simple numerical representations, Beta distributions as described above, and the like. The posterior probability distribution 240 may advantageously have the same form as the prior probability distribution 230, so that the posterior probability distribution can be obtained by modifying the prior probability distribution 230.

For each of the advertisements 111, the activation history 250 may provide data regarding how the advertisement has performed. The activation history 250 may be limited to the particular advertisement slot under consideration, or may include data regarding how the advertisement has performed in other contexts.

The activation history 250 may be generated in the course of asynchronous data collection. Logs indicating whether advertisements were activated may be monitored, to determine the results for a given advertisement and/or advertising slot. For example, for each advertisement and/or advertising slot, the number of impressions and the number of activations (such as clicks) may be retrieved.

This data may be sharded by factors such as the platform (for example, whether the viewer was using a desktop computer, mobile phone, and/or other device), the level of raciness of the advertisement (e.g., the degree to which the advertisement contains explicit, sexually suggestive, or otherwise adult-oriented content), and/or the like. This sharding process may provide a high degree of granularity in features on which statistical analysis can be performed. The latest information for each advertising slot, and/or the information for all active advertisements, may be retained and stored as the activation history 250.

The above-described process may result in the recordation of various data in the activation history 250. Such data may include features 260 that may optionally be used to provide additional granularity to the inferences that can be drawn from the activation history 250. In some embodiments, the features 260 may include, but are not limited to, the following:
The number of activations of the advertisement in any context, with no time limitation;
The number of times the advertisement was presented but not activated in any context, with no time limitation;
The number of activations of the advertisement in any context, within a certain recent time period;
The number of times the advertisement was presented but not activated in any context, within a certain recent time period;
The number of activations of the advertisement in the slot under consideration, with no time limitation;
The number of times the advertisement was presented but not activated in the slot under consideration, with no time limitation; and
The raciness of the content of the advertisement.
   These numbers of activations may be normalized, for example, across ten impressions, if desired.

Additionally or alternatively, the features 260 may include, for example, any of the advertisement context and/or user context features set forth previously. The features 260 may be used in the performance of Bayesian inference, as will be discussed in greater detail subsequently.

### Advertisement Placement System

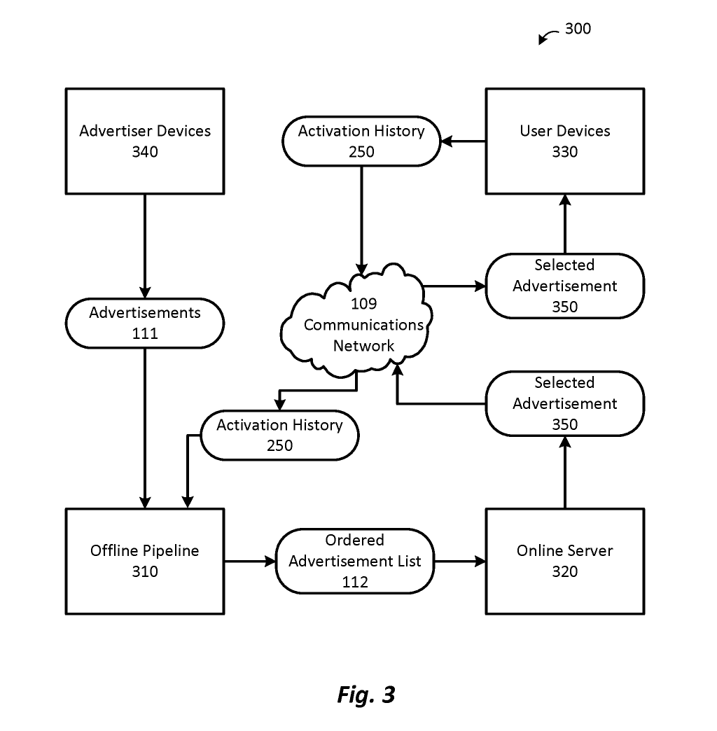

Referring to FIG. 3, a block diagram depicts a system 300 for determining advertisement placement, according to one embodiment. A wide variety of systems may be used to manage advertisement placement as disclosed herein. FIG. 3 represents only one of several possibilities. Various components present in the system 300 may be implemented as the devices 101, client devices 108, and/or servers 110 as shown and described in connection with FIGS. 1A and 1B. Further, the architectures of FIG. 2 may optionally be used, as will be described below.

As shown in FIG. 3, the system 300 may include various components, such as an offline pipeline 310 and an online server 320. The offline pipeline 310 and the online server 320 may cooperate to carry out advertisement placement. The offline pipeline 310 and the online server 320 may communicate with one or more user devices 330 and advertiser devices 340, either directly or via a communications network such as the communications network 109 of FIG. 1B, which may be the Internet.

The offline pipeline 310 may be the component that receives advertisements 111 from the advertiser devices 340 and applies Bayesian inference to generate the ordered advertisement lists 112. The advertisement list 112 may be generated such that one advertisement list 112 is provided for each advertising slot. Alternatively, one advertisement list 112 may be generated to cover multiple advertisement slots. The offline pipeline 310 may also receive the activation history 250, for example via the communications network 109, for the advertisements 111 to facilitate this process. The offline pipeline 310 may be built on MySQL and/or any other suitable platform.

The advertisement lists 112 may be provided to the online server 320, which may then select one of the advertisements 111 as a selected advertisement 350. The online server 320 may convey the selected advertisement 350 to one or more of the user devices 330 in which the advertising slot to be filled is present. The selected advertisement 350 may be transmitted to the user devices 330, for example, via the communications network 109.

In some embodiments, the online server 320 may deliver the advertisement 350 in real-time, i.e., as the advertising slot is loading. For example, when the user navigates to the page or site in which the advertising slot is present, the page or site may query the online server 320 for the advertisement to be presented to the user. The online server 320 may then deliver the advertisement 350 so that the advertisement 350 can be loaded in conjunction with the remainder of the page or site. Additionally or alternatively, one or more selected advertisements 350 may be uploaded and cached in the user devices 330 in advance, to expedite loading and/or presentation. The online server 320 may be built on MySQL and/or any other suitable platform.

As the user activates or does not activate the selected advertisement 350, activation history 250 may be generated. The activation history 250 may be transmitted by the user devices 330. In alternative embodiments, the activation history 250 may be generated by the online server 320 in conjunction with traffic monitoring occurring on the server (not shown) that hosts the landing page for the selected advertisement 350. In either case, the activation history 250 may be transmitted to the offline pipeline 310, for example, via the communications network 109.

The methods employed by the offline pipeline 310 to generate the advertisement lists 112 may involve the use of a mathematical idea based on “Inference in difference of proportions” to overcome the problems with traditional approaches in general. Conjugate priors may be used to overcome the “cold start” problem referenced previously. These statistical methods are described in Murphy, Kevin P., Machine Learning: A Probabilistic Perspective (Adaptive Computation and Machine Learning series) (Page 157). The MIT Press. Kindle Edition.

Inference in difference of proportions with conjugate priors can be helpful in situations in which there are multiple parameters, and it is desirable to compute the posterior distribution of some function of these parameters. For example, if there are two advertisements, a first advertisement that has been activated ten times over 100 impressions, and a second advertisement that has been activated twice over four impressions, it may be desirable to determine which of the advertisements is likely to have the highest CTR going forward, given just the limited activation history set forth above.

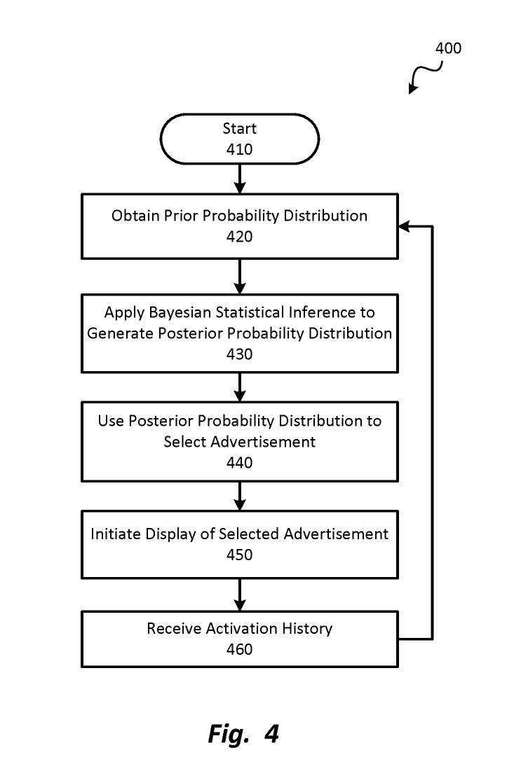

It might, at first, appear that the second advertisement has the better CTR, but given the very low number of impressions, it is desirable to undertake further study. A Bayesian analysis of this problem may be sketched as follows; this analysis will be extended in the discussion of FIG. 4 to the ad auction situation.

Let θ1 and θ2 be the unknown CTR of the first advertisement and the second advertisement, respectively. These CTR's may be expressed as Bernoulli distributions. Since little is known about them, they can both be endowed with uniform priors, θi˜Beta(1, 1). The posteriors are p(θ1|D1)=Beta(91, 11) and p(θ2|D2)=Beta(3, 1). The probability that θ1 is larger than θ2 may be computed as p(θ1>θ2|D). For convenience, δ=θ1−θ2 may be defined as the difference in the CTR's for the first advertisement and the second advertisement.

The desired quantity may be computed using numerical integration, for example, via the following formula:

p(δ>0|D)=∫₀¹∫₀¹(θ1>θ2)Beta(θ1|y1+1, N1−y1+1)Beta(θ2|y2+1, N2−y2+1)

where N1 and N2 are number of impressions of the first and second advertisements, respectively, and y1 and y2 are the number of activations of the first and second advertisements, respectively. Evaluating the integral may reveal that p(δ>0|D)=0.710, which means that the first advertisement is likely to have a higher CTR than the second advertisement going forward. Application of Bayesian inference to determine advertisement placement will be further described in connection with FIG. 4.

Referring to FIG. 4, a flowchart diagram depicts a method 400 for determining advertisement placement, according to one embodiment. The method 400 may be carried out through the use of various components of the system 300 of FIG. 3, such as the offline pipeline 310 and the online server 320. Additionally or alternatively, other systems may be used to carry out the method 400. Further, a system 300 such as that of FIG. 3 and/or the architectures of FIG. 2 may be used to carry out other methods of determining advertisement placement, besides the method 400 of FIG. 4.

As shown, the method 400 may start 410 with a step 420 in which the prior probability distribution 230 may be obtained for each of the advertisements 111 under consideration. If the method 400 has iterated previously for an advertisement, the prior probability distribution 230 may simply be the posterior probability distribution 240 that was obtained in the previous iteration. If the method 400 has not iterated previously for the advertisement, performance of the step 420 may entail generation of the prior probability distribution 230.

In many known methods of ad placement, a cold start problem may exist in situations where there is no activation history, as described previously. In such situations, it can be difficult to formulate the initial assumptions. If the prior probability distribution 230 needs to be generated, the step 420 may entail using activation history 250 for other advertisements 111. In some embodiments, the advertisements 111 may be grouped according to CPC, with advertisements 111 that fall within the same range of costs-per-click grouped together. The prior probability distribution 230 for an advertisement 111 may, in some embodiments, be generated based on the activation histories of advertisements 111 within the same CPC range as the advertisement 111 under consideration. For example, the activation history 250 of the advertisements 111 in the same CPC range may be evaluated to determine one or more of the following:
The total number of activations of the advertisements, with no time limitation; and
The total number of times the advertisements were presented but not activated, with no time limitation.

These numbers of activations may be normalized, for example, across ten impressions (or any other number of impressions), if desired. This information may be used to generate the prior probability distribution 230, thereby providing initial guidance for placement of advertisements 111 that is substantially better than a cold start with no information regarding activation probability.

In a step 430, Bayesian statistical inference may be applied to the prior probability distribution 230 to generate the posterior probability distribution 240. Various features 260, such as any of those listed above, may be used in the performance of the step 430. Then, in a step 440, the posterior probability distribution 240 may be used to select an advertisement for presentation to the user.

Performance of the step 440 may involve using the features referenced above to express the probability that the RPM of a first advertisement (“Promo1”) is better than that of a second advertisement (“Promo2”). These features may then be used to express the probability that the RPM obtained from showing Promo P1 is greater than that obtained from showing Promo P2. The step 440 may involve weighing the prior probability distribution 230 of an advertisement 111 against more recent activation history 250. The determination of how much the posterior probability distribution 240 is affected by each of these elements may be determined, in part, by the number of samples (i.e., impressions and/or activations) contained in the data for each of these elements.

In some embodiments, the performance of an advertisement may be viewed independently of the social context (for example, the social media site or page from which the viewer arrived at the advertisement), as well as in a manner that depends on the social context. For example, the probability of an advertisement being activated may be halfway determined with social context taken into account, and halfway determined without regard to the social context.

By way of example as to how the step 440 may be carried out, let E be the event that more revenue is obtained by showing Promo1 than by showing Promo2 in a given advertising slot, such as a gallery last-page advertisement:

E=Promo1_{RPM}>Promo2_{RPM}|Gallery

Then, probability can be expressed as:

P(E)=∫₀¹∫₀¹1(θ1,θ2, Promo1, Promo2)*B(θ1, Gallery, Promo1)*B(θ2, Gallery, Promo2)

### Further:

1(θ1,θ2, Promo1, Promo2)=1 if θ1*Promo1_{cpc}>θ2*Promo2_{cpc}

1(θ1,θ2, Promo1, Promo2)=0 if θ1*Promo1_{cpc}<=θ2*Promo2_{cpc}

B(θi, Gallery, Promoi)=0.5*U(θi|Gallery, Promoi)+05*R(θi|Gallery, Promoi)

R(θi|Gallery, Promoi)=Beta(θi|aᵣ, bᵣ)

aᵣ=GalleryPromoi_{PositiveImpressions}+Promoi_{RecentPositiveImpressions}+PositivePrior(Promoi_{cpc})

bᵣ=GalleryPromoi_{NegativeImpressions}+Promoi_{RecentNegativeImpressions}+NegativePrior(Promoi_{cpc})

U(θi|Gallery, Promoi)=Beta (θi|aᵤ, bᵤ)

aᵤ=GalleryPromoi_{PositiveImpressions}+PositivePrior(Promoi_{cpc})

bᵤ=GalleryPromoi_{NegativeImpressions}+NegativePrior(Promoi_{cpc})

Using the above formulation, advertisements (“Promos”) can be ordered for a given advertising slot, such as a gallery last-page advertisement, by sorting them on the probability that RPM from promo(i) is greater than promo(j). In this manner, the probable RPM and/or CTR of advertisements may be compared with each other. In some embodiments, pairs of the advertisements 111 for a given advertising slot may be compared with each other, and multiple combinations of pairings may be used according to any known methodology, such as a competition-style tree commonly used in tournaments.

The advertisements 111 may thus be ranked by probable RPM and/or CTR to generate the advertisement lists 112. This may be done by the offline pipeline 310 as described previously. In some embodiments, the following statistics may be denormed continuously using cron jobs (periodic jobs that can be scheduled in Linux):
1. For each advertisement, the number of times the advertisement has been activated or presented without activation within a recent period of time (for example, the results of the most recent 500 impressions);
2. For each advertisement, number of times the advertisement has been activated or presented without activation, with no time limitation;
3. For each pair of advertisements to be compared for a given advertising slot, the total number of times the advertisement has been activated or presented without activation; and
4. For each CPC range (0.1*i to 0.1*(i+1)) for i=0, 1, 2, . . . , the number of times the advertisement has been activated or presented without activation within a recent period of time (for example, within the last day).

With all of these statistics and the advertisements 111 on hand, the offline pipeline 310 may obtain the list of advertisements 111 suitable for each advertising slot, and order them by running the auction to determine the CPC 210 for each of the advertisements 111. The set of advertising slots for which the auction is run may include all advertising slots with recent activity, such as all of the advertising slots in which an advertisement 111 was activated during the last hour.

The offline pipeline 310 may operate across multiple advertising slots. Thus, in at least one embodiment, a multicore architecture may be used to run auctions for different advertising slots in parallel. After the auction is run, the advertisement lists 112 for each advertising slot may be cached in redis, which is a high-performance key-value store; alternatively, the advertisement lists 112 can be stored in some other suitable storage device. Advertising slots that receive more frequent clicks may be analyzed and/or updated more frequently (e.g., by updating the ordered advertisement list 112 for that advertising slot).

The advertisement lists 112 may be used by the online server 320 to determine which of the advertisements 111 to place in a given advertising slot. For example, the online server 320 may look up redis to obtain the appropriate ordered advertisement list(s) 112 for a given advertising slot, and may select the first advertisement 111 from the advertisement lists 112 that is eligible for presentation in the advertising slot. This advertisement 111 may be the selected advertisement 350 depicted in FIG. 3.

In a step 450, display of the selected advertisement 350 may be initiated. This may be done, for example, by transmitting a signal to each applicable user device 330, which may include the selected advertisement 350, to initiate display of the selected advertisement 350 in the advertising slot on the applicable user device 330. In a step 460, the activation history 250 may be received by the offline pipeline 310, for example, via the communications network 109 or directly from the advertiser devices 340, as described previously.

The method 400 may then repeat. New advertisements 111 may be continuously received and evaluated. The method 400 may return to the step 420 for each of the advertisements 111 under consideration. Where a posterior probability distribution 240 exists for an advertisement 111, performance of the step 420 may entail using the posterior probability distribution 240 from the previous iteration of the method 400 for the prior probability distribution 230 to be generated in the step 420.

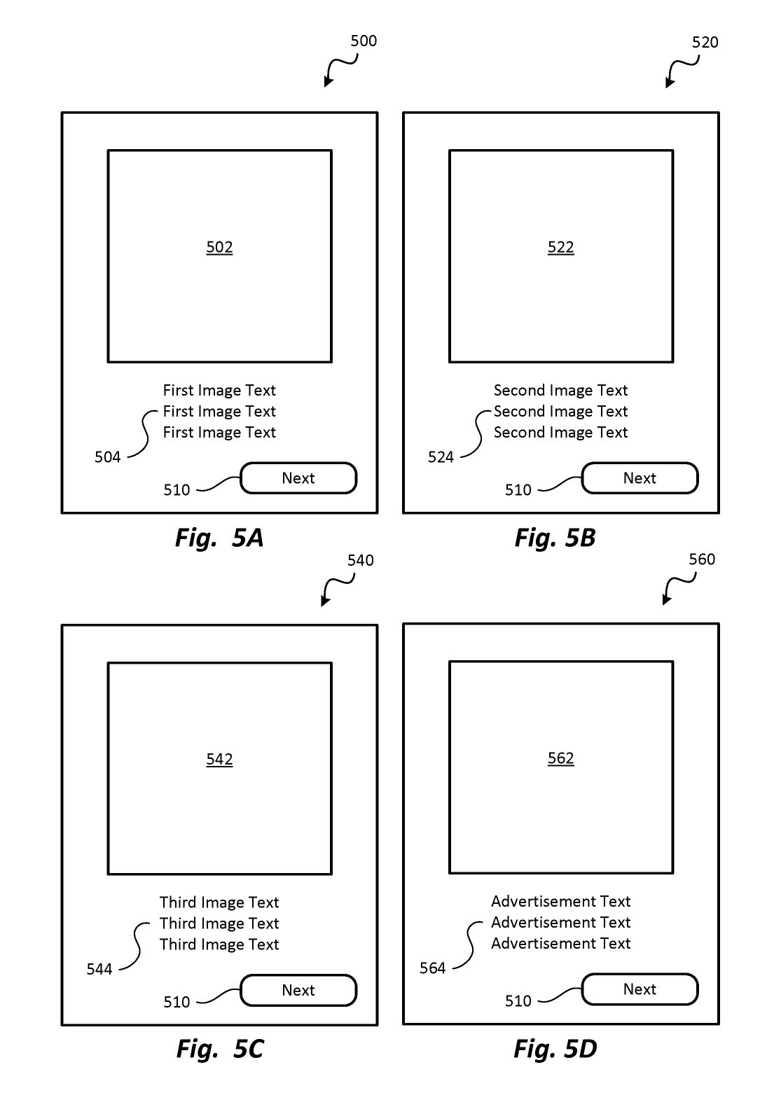

The method 400 is merely exemplary; other methods may be used within the scope of the present disclosure. Such methods may be used in a wide variety of advertising slots and/or platforms. As mentioned previously, such methods may advantageously be used to optimize advertisement placement in advertising slots that are accessed from social media. One example is gallery last-page advertisements, which will be described in connection with FIGS. 5A through 5D.

### Gallery Last-Page Advertisements

Referring to FIGS. 5A through 5D, screenshot diagrams 500, 520, 540, 560, respectively, depict various pages in a gallery, culminating in a gallery last-page advertisement, according to one embodiment. Specifically, a user may activate a link to the gallery from a web page, social media application, or the like. The link may indicate the content of the gallery. The gallery may use pictures, text, video, and/or sound to provide information.

For example, the gallery may have a first gallery page, shown in the screenshot diagram 500 of FIG. 5A. The first gallery page may have a first image 502 and first image text 504 that describes the first image 502 or is otherwise related to the first image 502. The first gallery page may also have a next button 510 that can be activated (for example, by clicking or tapping) by the user to advance to the second gallery page.

Similarly, the second gallery page may have a second image 522 and second image text 524, as depicted in the screenshot diagram 520 of FIG. 5B. The second gallery page may also display the next button 510, which may be activated by the user to navigate from the second gallery page to the third gallery page. The third gallery page may have a third image 542 and third image text 544, as depicted in the screenshot diagram 540 of FIG. 5C. The third gallery page may also display the next button 510, which may be activated by the user to navigate from the third gallery page to the last gallery page.

The last gallery page is depicted on the screenshot diagram 560 of FIG. 5D. The gallery last page may have an advertisement image 562 and advertisement text 564 that cooperate to indicate the subject matter of the advertisement 111. The advertisement image 562 and the advertisement text 564 may be the content 200 of the advertisement 111. The gallery last page may also display the next button 510, which may be activated by the user to navigate from the last gallery page to the landing page of the advertisement 111. Additionally or alternatively, the user may navigate to the advertisement by activating the advertisement image 562 and/or the advertisement text 564.

The gallery last-page advertisement is only one of many different advertisement types that may be enhanced and/or optimized through the use of the methods and systems of the present disclosure. Those of skill in the art will recognize that the systems and methods presented herein may be applied to a wide variety of different advertising situations.

One skilled in the art will recognize that the examples depicted and described herein are merely illustrative, and that other arrangements of user interface elements can be used. In addition, some of the depicted elements can be omitted or changed, and additional elements depicted, without departing from the essential characteristics.

The present system and method have been described in particular detail with respect to possible embodiments. Those of skill in the art will appreciate that the system and method may be practiced in other embodiments. First, the particular naming of the components, capitalization of terms, the attributes, data structures, or any other programming or structural aspect is not mandatory or significant, and the mechanisms and/or features may have different names, formats, or protocols. Further, the system may be implemented via a combination of hardware and software, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference in the specification to “one embodiment” or to “an embodiment” means that a particular feature, structure, or characteristic described in connection with the embodiments is included in at least one embodiment. The appearances of the phrases “in one embodiment” or “in at least one embodiment” in various places in the specification are not necessarily all referring to the same embodiment.

Various embodiments may include any number of systems and/or methods for performing the above-described techniques, either singly or in any combination. Another embodiment includes a computer program product comprising a non-transitory computer-readable storage medium and computer program code, encoded on the medium, for causing a processor in a computing device or other electronic device to perform the above-described techniques.

Some portions of the above are presented in terms of algorithms and symbolic representations of operations on data bits within a memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects include process steps and instructions described herein in the form of an algorithm. It should be noted that the process steps and instructions can be embodied in software, firmware and/or hardware, and when embodied in software, can be downloaded to reside on and be operated from different platforms used by a variety of operating systems.

The present document also relates to an apparatus for performing the operations herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, DVD-ROMs, magnetic-optical disks, read-only memories (ROMs), random access memories (RAMs), EPROMs, EEPROMs, flash memory, solid state drives, magnetic or optical cards, application specific integrated circuits (ASICs), or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the system and method are not described with reference to any particular programming language. It will be appreciated that a variety of programming languages may be used to implement the teachings described herein, and any references above to specific languages are provided for disclosure of enablement and best mode.

Accordingly, various embodiments include software, hardware, and/or other elements for controlling a computer system, computing device, or other electronic device, or any combination or plurality thereof. Such an electronic device can include, for example, a processor, an input device (such as a keyboard, mouse, touchpad, track pad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or non-portable. Examples of electronic devices that may be used for implementing the described system and method include: a mobile phone, personal digital assistant, smartphone, kiosk, server computer, enterprise computing device, desktop computer, laptop computer, tablet computer, consumer electronic device, or the like. An electronic device may use any operating system such as, for example and without limitation: Linux; Microsoft Windows, available from Microsoft Corporation of Redmond, Wash.; Mac OS X, available from Apple Inc. of Cupertino, Calif.; iOS, available from Apple Inc. of Cupertino, Calif.; Android, available from Google, Inc. of Mountain View, Calif.; and/or any other operating system that is adapted for use on the device.

While a limited number of embodiments have been described herein, those skilled in the art, having benefit of the above description, will appreciate that other embodiments may be devised. In addition, it should be noted that the language used in the specification has been principally selected for readability and instructional purposes, and may not have been selected to delineate or circumscribe the subject matter. Accordingly, the disclosure is intended to be illustrative, but not limiting, of scope.

What is claimed is:

1. A method for selecting one of a plurality of advertisements to display on a computing device, the method comprising:
at a processor, obtaining a prior probability distribution indicative of relative likelihood of activation of the plurality of advertisements by a user;
at the processor, applying Bayesian statistical inference to the prior probability distribution to generate a posterior probability distribution that is also indicative of relative likelihood of activation of the plurality of advertisements by the user;
at the processor, using the posterior probability distribution to select a first advertisement from the plurality of advertisements; and
at a communication device, transmitting a signal to cause the first advertisement to be displayed to the user.

2. The method of claim 1, wherein obtaining the prior probability distribution comprises generating the prior probability distribution independently of any activation history of the plurality of advertisements.

3. The method of claim 2, wherein:
generating the prior probability distribution comprises utilizing other activation history for other advertisements excluding the plurality of advertisements;
the plurality of advertisements are from advertisers offering a range of costs per click for each user activation of the plurality of advertisements;
the other advertisements are from other advertisers offering an other range of costs per click for each user activation of the other advertisements;
the other range of costs per click is the same as or similar to the range of costs per click; and
the other activation history is indicative of a number of times the other advertisements have been activated by users.

4. The method of claim 1, wherein obtaining the prior probability distribution comprises:
at the processor, obtaining a previous prior probability distribution indicative of relative likelihood of activation of the plurality of advertisements by a user;
at the processor, applying Bayesian statistical inference to the previous prior probability distribution to generate a previous posterior probability distribution that is also indicative of relative likelihood of activation of the plurality of advertisements by the user; and
at the processor, designating the previous posterior probability distribution as the prior probability distribution.

5. The method of claim 1, wherein using the posterior probability distribution to select the first advertisement from the plurality of advertisements comprises determining that the first advertisement is more likely to be activated by the user than a second advertisement of the plurality of advertisements.

6. The method of claim 5, wherein using the posterior probability distribution to select the first advertisement from the plurality of advertisements further comprises determining that the first advertisement is more likely to be activated by the user than a third advertisement of the plurality of advertisements.

7. The method of claim 1, wherein applying Bayesian statistical inference to the prior probability distribution to generate the posterior probability distribution comprises:
from a data store, retrieving activation history indicative of a number of times the plurality of advertisements have been activated by users; and
generating the posterior probability distribution based, at least partially, on the activation history.

8. The method of claim 7, wherein the activation history comprises a plurality of features for each advertisement of the plurality of advertisements, wherein the plurality of features comprise a number of times the advertisement has been activated, with no time limit.

9. The method of claim 7, wherein the activation history comprises a plurality of features for each advertisement of the plurality of advertisements, wherein the plurality of features comprise a number of times the advertisement has been activated within a recent window of time.

10. The method of claim 7, wherein the activation history comprises a plurality of features for each advertisement of the plurality of advertisements, wherein the plurality of features comprise a number of times the advertisement has been activated on a venue in which the advertisement is to be displayed for the user, with no time limit.

11. The method of claim 1, wherein transmitting a signal to cause the first advertisement to be displayed to the user comprises causing the first advertisement to be displayed on a last page of a gallery of content selected for display by the user.

12. A non-transitory computer-readable medium for selecting one of a plurality of advertisements to display on a computing device, comprising instructions stored thereon, that when executed by a processor, perform the steps of:
obtaining a prior probability distribution indicative of relative likelihood of activation of the plurality of advertisements by a user;
applying Bayesian statistical inference to the prior probability distribution to generate a posterior probability distribution that is also indicative of relative likelihood of activation of the plurality of advertisements by the user;
using the posterior probability distribution to select a first advertisement from the plurality of advertisements; and
causing a communication device to transmit a signal to cause the first advertisement to be displayed to the user.

13. The non-transitory computer-readable medium of claim 12, wherein obtaining the prior probability distribution comprises generating the prior probability distribution independently of any activation history of the plurality of advertisements.

14. The non-transitory computer-readable medium of claim 13, wherein:
generating the prior probability distribution comprises utilizing other activation history for other advertisements excluding the plurality of advertisements;
the plurality of advertisements are from advertisers offering a range of costs per click for each user activation of the plurality of advertisements;
the other advertisements are from other advertisers offering an other range of costs per click for each user activation of the other advertisements;
the other range of costs per click is the same as or similar to the range of costs per click; and
the other activation history is indicative of a number of times the other advertisements have been activated by users.

15. The non-transitory computer-readable medium of claim 12, wherein obtaining the prior probability distribution comprises:
obtaining a previous prior probability distribution indicative of relative likelihood of activation of the plurality of advertisements by a user;
applying Bayesian statistical inference to the previous prior probability distribution to generate a previous posterior probability distribution that is also indicative of relative likelihood of activation of the plurality of advertisements by the user; and
designating the previous posterior probability distribution as the prior probability distribution.

16. The non-transitory computer-readable medium of claim 12, wherein using the posterior probability distribution to select the first advertisement from the plurality of advertisements comprises determining that the first advertisement is more likely to be activated by the user than a second advertisement of the plurality of advertisements.

17. The non-transitory computer-readable medium of claim 12, wherein applying Bayesian statistical inference to the prior probability distribution to generate the posterior probability distribution comprises:
from a data store, retrieving activation history indicative of a number of times the plurality of advertisements have been activated by users; and
generating the posterior probability distribution based, at least partially, on the activation history.

18. The non-transitory computer-readable medium of claim 17, wherein the activation history comprises a plurality of features for each advertisement of the plurality of advertisements, wherein the plurality of features comprise at least one selection from the group consisting of:
a number of times the advertisement has been activated, with no time limit;
a number of times the advertisement has been activated within a recent window of time; and
a number of times the advertisement has been activated on a venue in which the advertisement is to be displayed for the user, with no time limit.

19. The non-transitory computer-readable medium of claim 12, wherein transmitting a signal to cause the first advertisement to be displayed to the user comprises causing the first advertisement to be displayed on a last page of a gallery of content selected for display by the user.

20. A system for selecting one of a plurality of advertisements to display on a computing device, the system comprising:
a processor configured to:
obtain a prior probability distribution indicative of relative likelihood of activation of the plurality of advertisements by a user;
apply Bayesian statistical inference to the prior probability distribution to generate a posterior probability distribution that is also indicative of relative likelihood of activation of the plurality of advertisements by the user; and
use the posterior probability distribution to select a first advertisement from the plurality of advertisements; and
a communication device, communicatively coupled to the processor, configured to transmit a signal to cause the first advertisement to be displayed to the user.

21. The system of claim 20, wherein the processor is further configured to obtain the prior probability distribution by generating the prior probability distribution independently of any activation history of the plurality of advertisements.

22. The system of claim 21, wherein:
the processor is further configured to generate the prior probability distribution by utilizing other activation history for other advertisements excluding the plurality of advertisements;
the plurality of advertisements are from advertisers offering a range of costs per click for each user activation of the plurality of advertisements;
the other advertisements are from other advertisers offering an other range of costs per click for each user activation of the other advertisements;
the other range of costs per click is the same as or similar to the range of costs per click; and
the other activation history is indicative of a number of times the other advertisements have been activated by users.

23. The system of claim 20, wherein the processor is further configured to obtain the prior probability distribution by:
obtaining a previous prior probability distribution indicative of relative likelihood of activation of the plurality of advertisements by a user;
applying Bayesian statistical inference to the previous prior probability distribution to generate a previous posterior probability distribution that is also indicative of relative likelihood of activation of the plurality of advertisements by the user; and
designating the previous posterior probability distribution as the prior probability distribution.

24. The system of claim 20, wherein the processor is further configured to use the posterior probability distribution to select the first advertisement from the plurality of advertisements by determining that the first advertisement is more likely to be activated by the user than a second advertisement of the plurality of advertisements.

25. The system of claim 20, further comprising a data store communicatively coupled to the processor;
wherein the processor is further configured to apply Bayesian statistical inference to the prior probability distribution to generate the posterior probability distribution by:
from the data store, retrieving activation history indicative of a number of times the plurality of advertisements have been activated by users; and
generating the posterior probability distribution based, at least partially, on the activation history.

26. The system of claim 25, wherein the activation history comprises a plurality of features for each advertisement of the plurality of advertisements, wherein the plurality of features comprise at least one selection from the group consisting of:
a number of times the advertisement has been activated, with no time limit;
a number of times the advertisement has been activated within a recent window of time; and
a number of times the advertisement has been activated on a venue in which the advertisement is to be displayed for the user, with no time limit.

27. The system of claim 20, wherein the communications device is further configured to transmit a signal to cause the first advertisement to be displayed to the user by causing the first advertisement to be displayed on a last page of a gallery of content selected for display by the user.
